(19) United States
(12) Patent Application Publication
(10) Pub. No.: US 2021/0260751 A1
(43) Pub. Date: Aug. 26, 2021

(54) ROBOTIC ARM ASSEMBLY EQUIPPED WITH ELBOW HARD STOP

(71) Applicant: Fabworx Solutions, Inc., Austin, TX (US)

(72) Inventors: Daniel Alaniz, Liberty Hill, TX (US); Thomas Walton, Manor, TX (US); Michael Dailey, Austin, TX (US)

(21) Appl. No.: 17/256,612

(22) PCT Filed: Jun. 27, 2019
(86) PCT No.: PCT/US2019/039357

§ 371 Date: Dec. 28, 2020

Related U.S. Application Data
(60) Provisional application No. 62/690,854, filed on Jun. 27, 2018.

(51) Int. Cl. B25J 9/04; B25J 9/10; B25J 11/00

(52) U.S. Cl. CPC B25J 9/042; B25J 11/0095; B25J 9/107; B25J 9/101

(57) ABSTRACT

A robot is provided which includes a hub; an elbow joint; a wrist assembly; a first upper arm which is rotatably attached on a first end thereof to the hub, and which is attached on a second end thereof to the elbow joint; a first lower arm which is attached on a first end thereof to the elbow joint, and which is attached on a second end thereof to the wrist assembly; and a hard stop which extends over the elbow joint and a portion of the lower arm. The hard stop prevents the wrist assembly from contacting the hub when the motor of the robot is not engaged.

### CROSS-REFERENCE TO RELATED APPLICATION

The present application is a national stage filing of PCT/US2019/039357, filed on Jun. 27, 2019, which has the same title and the same inventors, and which is incorporated herein by reference in its entirety; which claims the benefit of priority of U.S. Patent Application No. 62/690,854, filed Jun. 27, 2018, having the same inventors and entitled “ROBOTIC ARM ASSEMBLY EQUIPPED WITH ELBOW HARD STOP,” which is incorporated herein by reference in its entirety.

### FIELD OF THE DISCLOSURE

The present application relates generally to robotic arm assemblies, and more particularly to arm assemblies equipped with elbow hard stops.

### BACKGROUND OF THE DISCLOSURE

In a typical semiconductor manufacturing process, a single wafer may be exposed to a number of sequential processing steps including, but not limited to, chemical vapor deposition (CVD), physical vapor deposition (PVD), etching, planarization, and ion implantation. These processing steps are typically performed by robots, due in part to the ability of robots to perform repetitive tasks quickly and accurately and to work in environments that are dangerous to humans.

Many modern semiconductor processing systems are centered around robotic cluster tools that integrate a number of process chambers. This arrangement allows multiple sequential processing steps to be performed on the wafer within a highly controlled processing environment, and thus minimizes exposure of the wafer to external contaminants. The combination of chambers in a cluster tool, as well as the operating conditions and parameters under which those chambers are utilized, may be selected to fabricate specific structures using a specific process recipe and process flow. Some commonly used process chambers include degas chambers, substrate pre-conditioning chambers, cool down chambers, transfer chambers, chemical vapor deposition chambers, physical vapor deposition chambers and etch chambers.

One example of a known cluster tool is disclosed in U.S. Pat. No. 6,222,337 (Kroeker et al.), which is reproduced in FIG. 1 herein. The cluster tool 10 disclosed therein features robots 14, 28 having a frog-leg construction. Such robots are adapted to provide both radial and rotational movement of their associated end effector blades 17 within a fixed plane. These radial and rotational movements may be coordinated or combined to allow wafers 32 to be picked up, transferred and delivered from one processing chamber to another processing chamber within the cluster tool 10.

With reference to FIG. 1, wafers are introduced into, and withdrawn from, the cluster tool 10 through a cassette loadlock 12. In the particular cluster tool depicted, a first robot 14 having a wafer plate blade 17 end effector is located within a chamber 18 and is utilized to transfer wafers 32 among a first set of processing chambers. In the particular embodiment depicted, these processing chambers include the aforementioned cassette loadlock 12, a degas wafer orientation chamber 20, a preclean chamber 24, a PVD TiN chamber 22 and a cooldown chamber 26. The robot 14 is illustrated in the retracted position in which it can rotate freely within transfer chamber 18.

A second robot 28 is located in transfer chamber 30 and is adapted to transfer substrates between a second set of process chambers. In the particular embodiment depicted, the second set of process chambers includes a cool down chamber 26 and a pre-clean chamber 24, and may also include a CVD Al chamber and a PVD AlCu processing chamber. The specific configuration of chambers in the cluster tool 10 is designed to provide an integrated processing system capable of both CVD and PVD processes in a single tool. A microprocessor controller 29 is provided to control the fabricating process sequence, conditions within the cluster tool, and the operation of the robots 14, 28.

FIG. 2 depicts an example of a robot which may be used in the cluster tool of FIG. 1. The particular robot 101 depicted in FIG. 2 has a double frog-leg design and features first 103 and second 105 pairs of arms which are attached on one end to a wrist assembly 107, and which are attached on the other end to an elbow joint 109. Each wrist assembly 107 is in turn attached to an end effector 111 which is used to handle a semiconductor wafer. The robot 101 is further equipped with upper arms 113, 115 which are mounted on the upper 117 and lower 119 rotatable rings of a hub 121. The robot 101 further comprises a monolithic hub plate 123 upon which the hub 121 is mounted, and a motor 125 which drives the upper 117 and lower 119 rotatable rings. The hub 121 and hub plate 123 together constitute a hub assembly 124.

One robot commonly utilized in the cluster tool of FIG. 1 is the Endura XP robot depicted in FIG. 3. As seem therein, the XP Endura robot 201 comprises a hub 203 which is mounted on a hub spool 205. First and second upper arms 207 are rotatably mounted on the hub 203 such that a first end of each of the first and second upper arms 207 is rotatably attached to the hub, and a second end of each of the first and second upper arms 207 has an elbow joint 209 rotatably attached thereto. The robot further comprises first and second lower arms 211, and a wrist assembly 213. Each of the first and second lower arms 211 is attached on a first end thereof to the first and second elbow joints 209, respectively, and is attached on a second end thereof to the wrist assembly 213.

The XP Endura robot has been commercialized as part of a 300 mm metal deposition system optimized for high volume production. The system combines a factory interface with two vacuum wafer handling robots controlled by system software. With this system, chipmakers are able to operate advanced wafer processing sequences (such as, for example, copper deposition on low x dielectric) with high wafer throughput for low-cost, high yield semiconductor manufacturing.

### BRIEF DESCRIPTION OF THE DRAWINGS

FIG. 1 is a top view of a semiconductor tool equipped with processing chambers and with robots having a frog-leg design.

FIG. 2 is a perspective view of a prior art semiconductor robot of a type that may be used in a tool such as that depicted in FIG. 1.

FIG. 3 is a perspective view of an XP Endura robot.

FIG. 4 is a perspective view of stacked XP Endura robots which shows one of the robots in a retracted configuration, and which shows the other robot in an extended configuration.

FIG. 5 is a top view of a portion of an XP Endura robot shown in a compacted configuration frequently used for shipping the robot.

FIG. 6 is a perspective view of an embodiment of an XP Endura robot equipped with a hard stop in accordance with the teachings herein.

FIG. 7 is an exploded view of the elbow assembly and hard stop of FIG. 6.

FIG. 8 is an exploded view of the hard stop of FIG. 6.

FIG. 9 is a perspective view of the elbow joint portion of the robot of FIG. 6 with the cover plate rendered transparent.

FIG. 10 is a perspective view of a portion of the lower arm of then robot of FIG. 6.

FIG. 11 is a first cross-sectional view of the elbow assembly and hard stop of FIG. 7.

FIG. 12 is a second cross-sectional view of the elbow assembly and hard stop of FIG. 6.

FIG. 13 is a perspective view of the hard stop of FIG. 8.

FIGS. 14-15 are perspective views of the hard stop of FIG. 8.

FIG. 16 is a perspective view of the body of the hard stop of FIG. 8.

FIG. 17 is a top view of the body of the hard stop of FIG. 8.

FIG. 18 is a bottom view of the body of the hard stop of FIG. 8.

### SUMMARY OF THE DISCLOSURE

In one aspect, a robot is provided which comprises a hub; a first elbow joint; a wrist assembly; a first upper arm rotatably attached on a first end thereof to said hub, and attached on a second end thereof to said first elbow joint; a first lower arm attached on a first end thereof to said first elbow joint, and attached on a second end thereof to said wrist assembly; and a first hard stop which extends over said first elbow joint and a portion of said lower arm, wherein said first hard stop has an aperture therein through which said lower arm extends; wherein said robot is movable between a first configuration in which said wrist assembly is at a minimum distance from said hub, and a second configuration in which said wrist assembly is at a maximum distance from said hub; wherein said lower arm rotates towards said upper arm as said robot moves from said second configuration into said first configuration; and wherein said first hard stop has an exterior surface region which abuts said upper arm when said robot is in said first configuration.

In another aspect, a method is provided for restricting the motion of an elbow joint in a robot. The method comprises (a) providing a robot equipped with (i) a hub, (ii) a first elbow joint, (iii) a wrist assembly, (iv) a first upper arm rotatably attached on a first end thereof to said hub, and attached on a second end thereof to said first elbow joint, and (v) a first lower arm attached on a first end thereof to said first elbow joint, and attached on a second end thereof to said wrist assembly, wherein said robot is movable between a first configuration in which said wrist assembly is at a minimum distance from said hub, and a second configuration in which said wrist assembly is at a maximum distance from said hub, and wherein said lower arm rotates towards said upper arm as said robot moves from said second configuration into said first configuration; and applying a first hard stop which extends over said first elbow joint and a portion of said lower arm, wherein said first hard stop has an aperture therein through which said lower arm extends, and wherein said hard stop maintains the upper and lower arms in a spaced apart configuration when the robot is in the first configuration.

### DETAILED DESCRIPTION

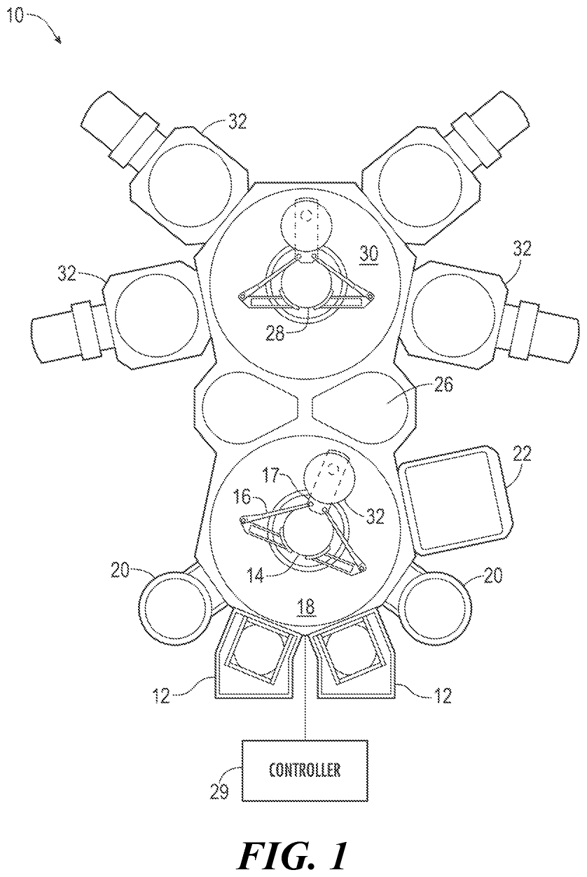

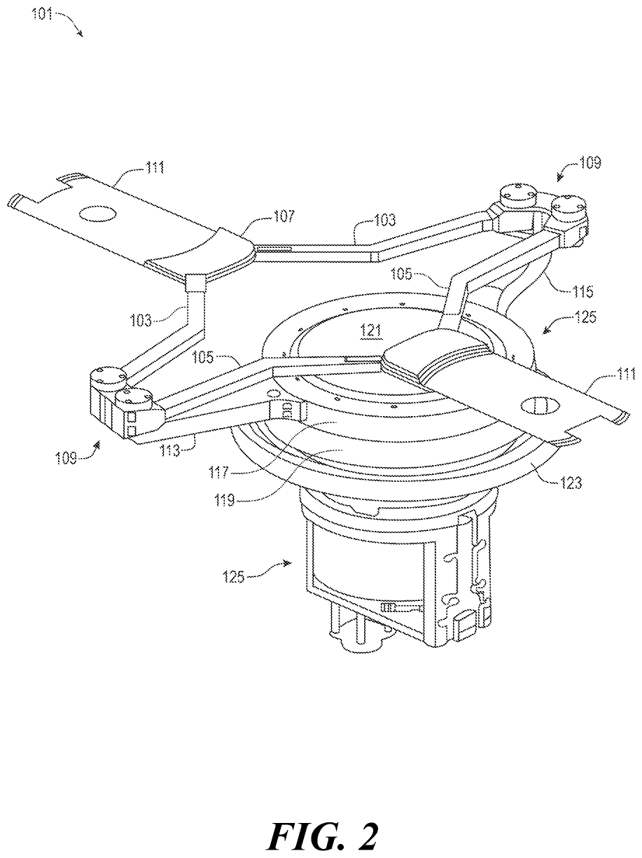

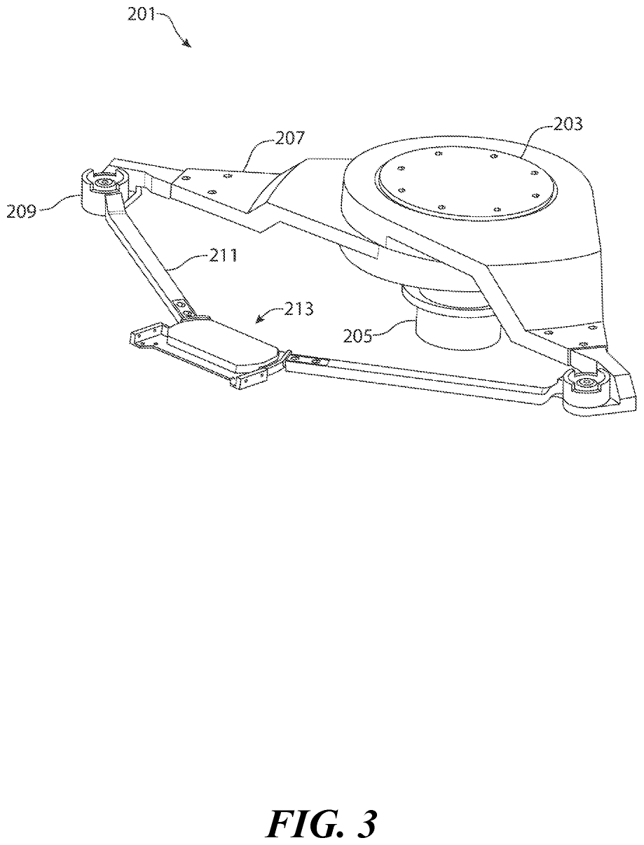

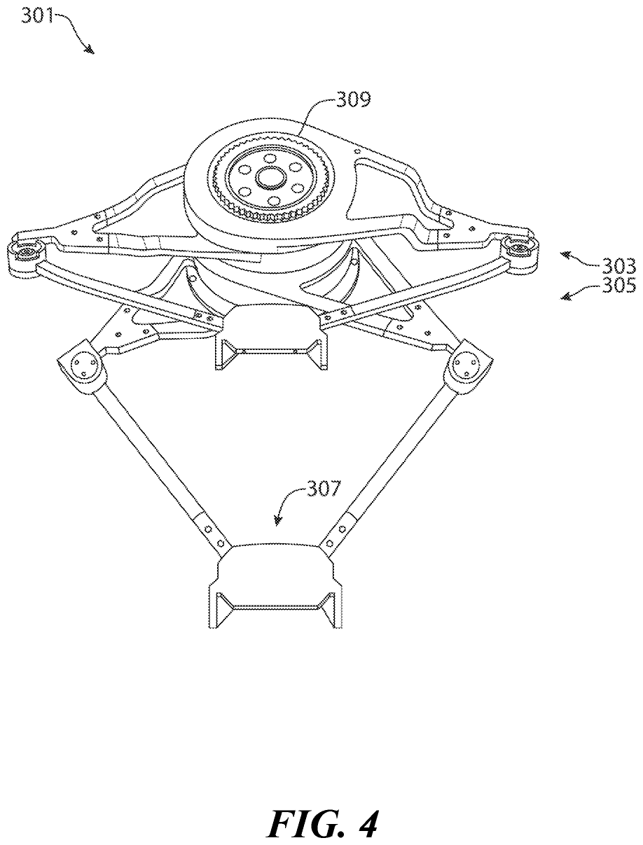

While the XP Endura robot has achieved widespread commercial application, it nonetheless suffers from some infirmities. One of these infirmities is associated with the range of motion of the wrist assembly with respect to the hub assembly or hub spool. This range of motion may be appreciated from FIG. 4, which depicts a robotic assembly 301 which includes first 303 and second 305 stacked XP Endura robots. As seen therein, the XP Endura robot is designed to move between a retracted configuration (held by robot 303) in which the distance between the wrist assembly 307 and the hub spool 309 is at a minimum, and an extended configuration (held by robot 305) in which the distance between the wrist assembly 307 and the hub spool 309 is at a maximum. This motion allows each of the robots 303, 305 to place wafers into, and remove wafers from, the processing chambers commonly included in the tool of which the robot is a component (see FIG. 1).

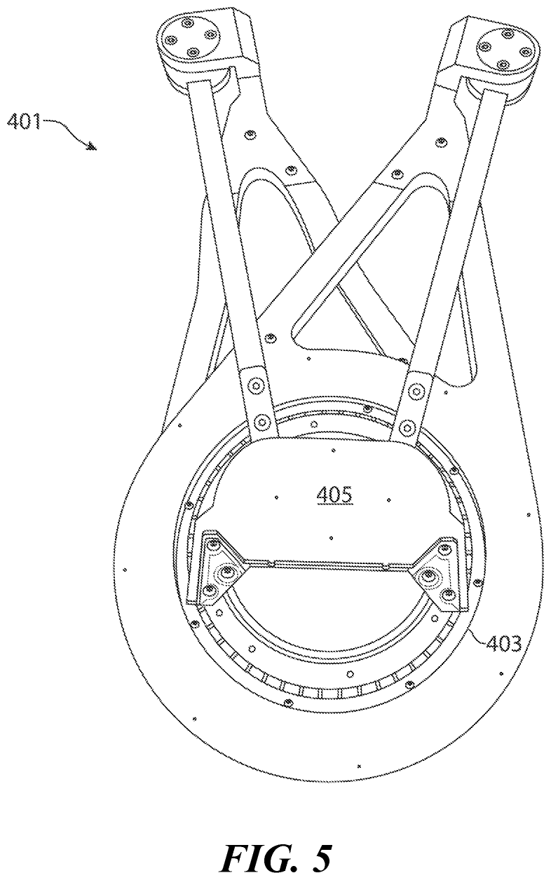

When its motors are disengaged, the XP Endura robot is actually capable of a greater range of motion than typically utilized in its everyday use. Thus, as seen in FIG. 5, the robot 401 has sufficient range of motion such that, if the hub (not shown) is removed from the robot 401, the wrist assembly 405 can actually overlap the space that would normally be occupied by the hub. Indeed, this highly compact configuration may be utilized advantageously when the robot 401 is being shipped.

Unfortunately, although the ability of the XP Endura robot to move over this range has some benefits, it also creates problems during maintenance of the robot. In particular, during normal use, the motors of the robot prevent the wrist assembly from contacting the spool, hub or upper arms as the robot assumes a retracted configuration. However, when the robot's motors are disengaged, the range of motion of the robot is no longer restricted, and the wrist assembly can move far enough to come into contact with one or more of these items. This issue occurs mainly during repairs or routine maintenance, at which time the robot can be manually rotated. By physically retracting the robot's arms and allowing the backend of the wrist assembly to touch other parts of the robot, any subsequent movements may result in abrasion between the wrist assembly and these other parts. This abrasion has been found to generate significant amounts of metal shavings and other particles, which may lead to wafer contamination problems and other issues.

It has now been found that the foregoing problem may be overcome with the devices and methodologies disclosed herein. In a preferred embodiment, these devices and methodologies feature a hard stop (also referred to herein as an OD clamp) which may be installed on a robotic elbow joint (such as that in an XP Endura robot). Such a hard stop physically prevents the wrist assembly from coming into contact with other parts of the robot, even when the motors in the robot are disengaged. Consequently, use of these hard stops reduces or eliminates particle generation and other issues that may otherwise occur during repair or maintenance of the robot, or at other times in which the motor of the robot is disengaged.

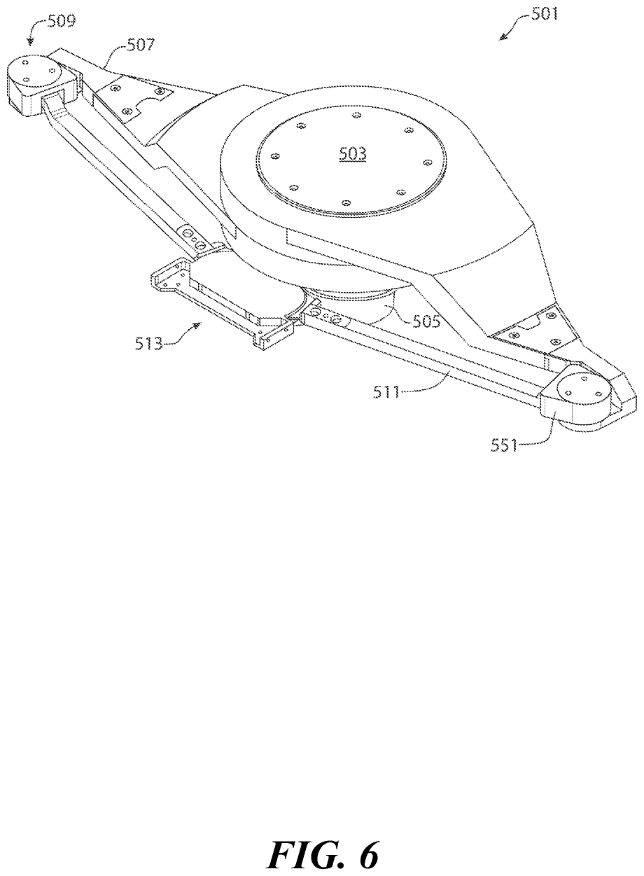

FIG. 6 depicts a first particular, non-limiting embodiment of a robot equipped with a hard stop in accordance with the teachings herein. As seen therein, the robot 501 (which, in the particular embodiment depicted, is an XP Endura robot) comprises a hub 503 which is mounted on a hub spool 505. First and second upper arms 507 are rotatably mounted on the hub 503 such that a first end of each of the first and second upper arms 507 is rotatably attached to the hub 503, and a second end of each of the first and second upper arms 507 is equipped with an elbow joint 509 which is rotatably attached thereto. The robot 501 further comprises first and second lower arms 511, and a wrist assembly 513. Each of the first and second lower arms 511 is attached on a first end thereof to the first and second elbow joints 509, respectively, and is attached on a second end thereof to the wrist assembly 513.

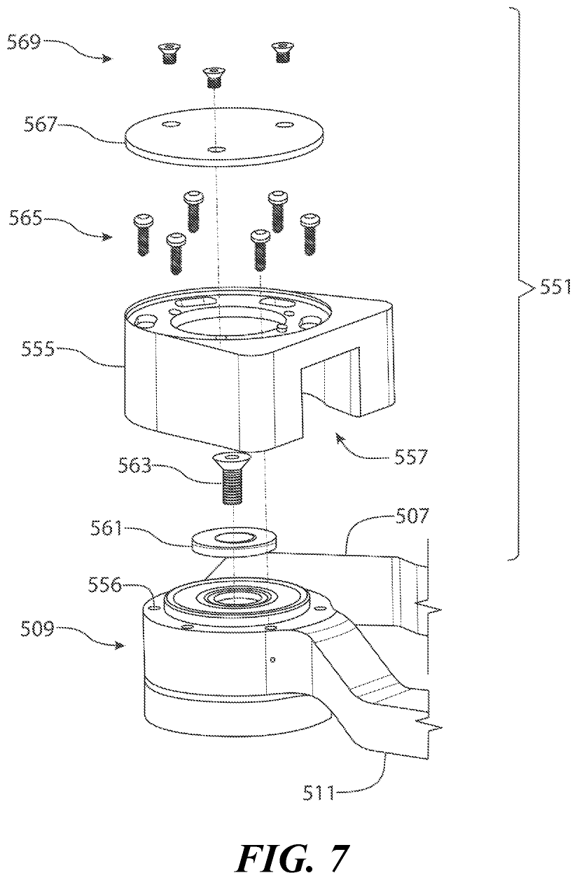

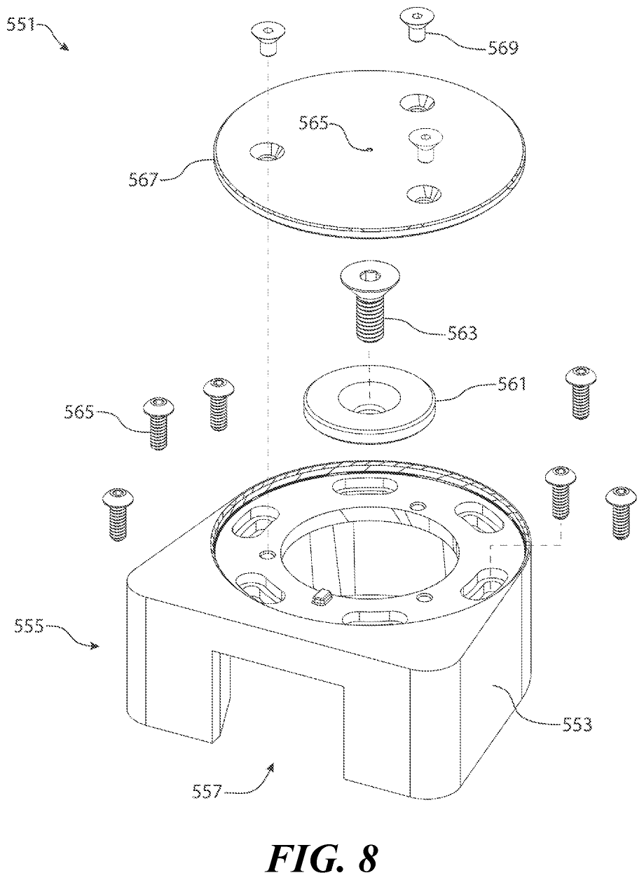

The robot 501 of FIG. 6 further comprises a hard stop 551 which is installed on each of the first and second elbow joints 509. The hard stop 551 in the particular embodiment depicted is equipped with a housing or body 555 (see FIGS. 7-8) having opposing flattened lateral surfaces 553 (see FIG. 8) that are complimentary in shape to an opposing portion of the upper arm 507.

In use, the robot is designed to move between a retracted configuration in which the distance between the wrist assembly 513 and the hub 503 is at a minimum, and an extended configuration in which the distance between the wrist assembly 513 and the hub 503 is at a maximum, similar to the configurations depicted in FIG. 4. This motion allows the robot 501 to place wafers in, and retrieve wafers from, the processing chambers of a semiconductor processing tool. However, the hard stops 551 act as a mechanical barrier to prevent the wrist assembly 513 from coming into contact with the hub spool 505 or other parts of the robot, even when the motors in the robot 501 are disengaged. Consequently, the use of such hard stops 551 overcomes the problems with particle generation noted above.

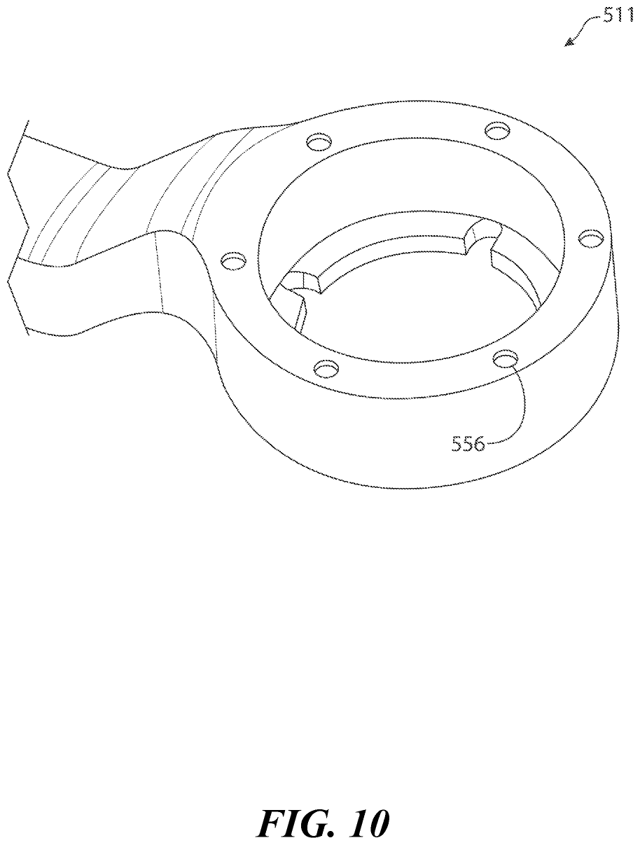

The construction of the hard stop 551 may be further appreciated with respect to FIGS. 7-8. As seen therein, the hard stop 551 comprises a body 555 having an opening 557 therein to accommodate the lower arm 511 (see FIG. 7) of the robot 501, and an interior which is complimentary in shape to the exterior surfaces of the elbow joint 509 (see FIG. 7). This geometry allows the hard stop 551 to be placed over the elbow joint 509 (the portion of the elbow joint 509 formed by the lower arm 511 is depicted in FIG. 10). The body 555 also has a (preferably flattened) surface 553 (see FIG. 8) on the exterior thereof which, as noted above, is preferably complimentary in shape to an opposing portion of the upper arm 507 of the robot 501 (see FIG. 6).

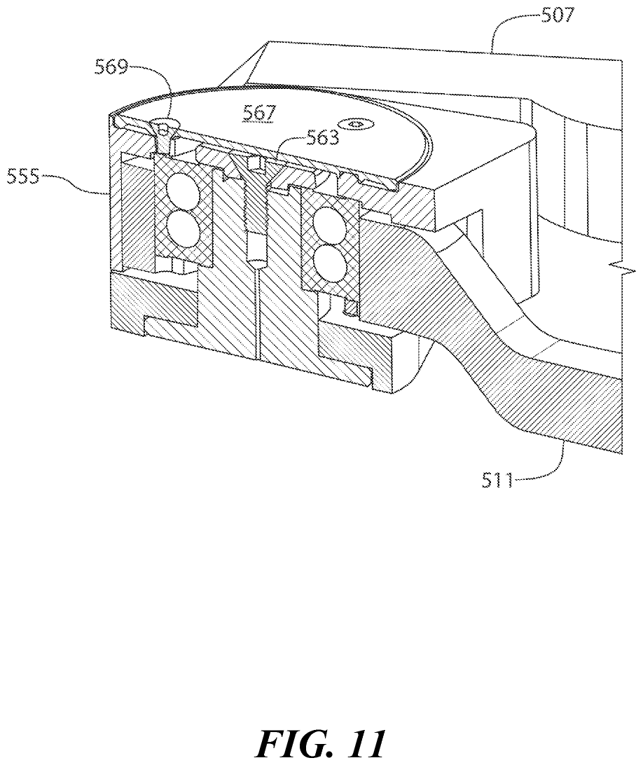

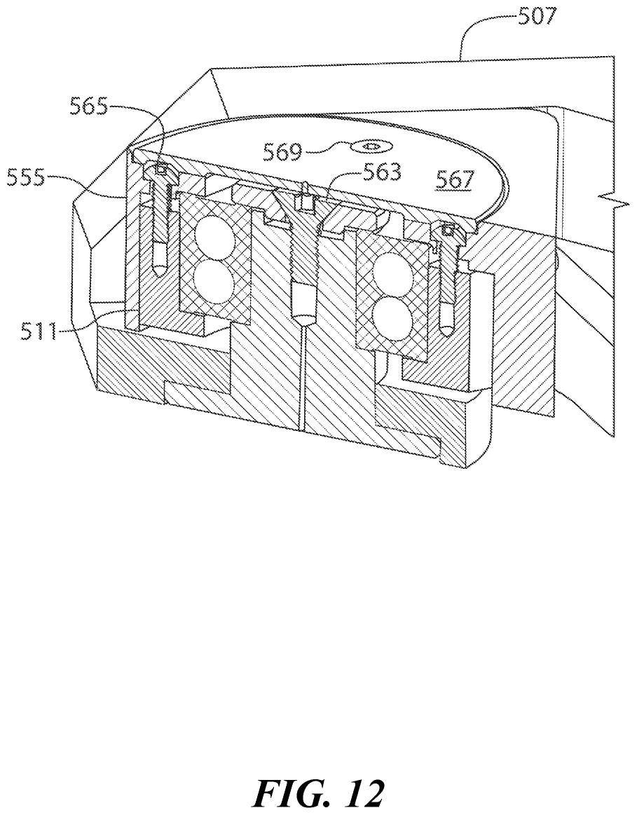

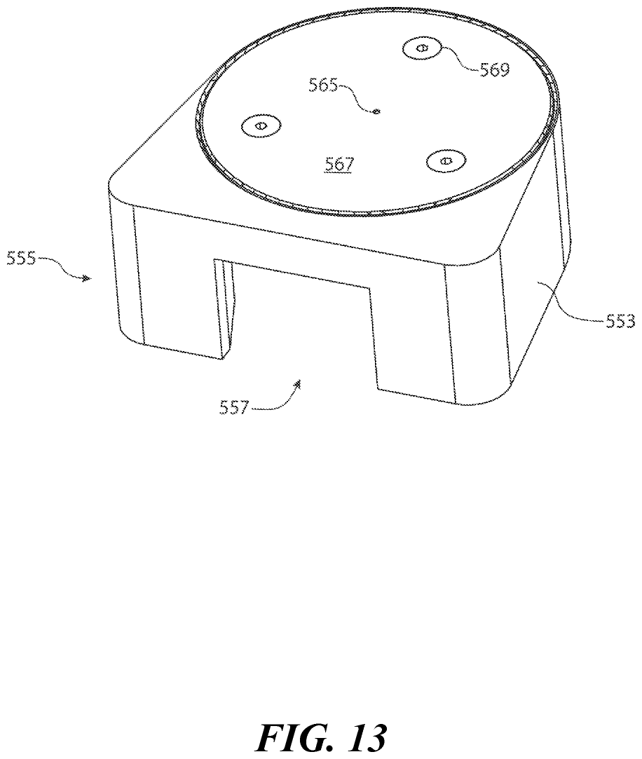

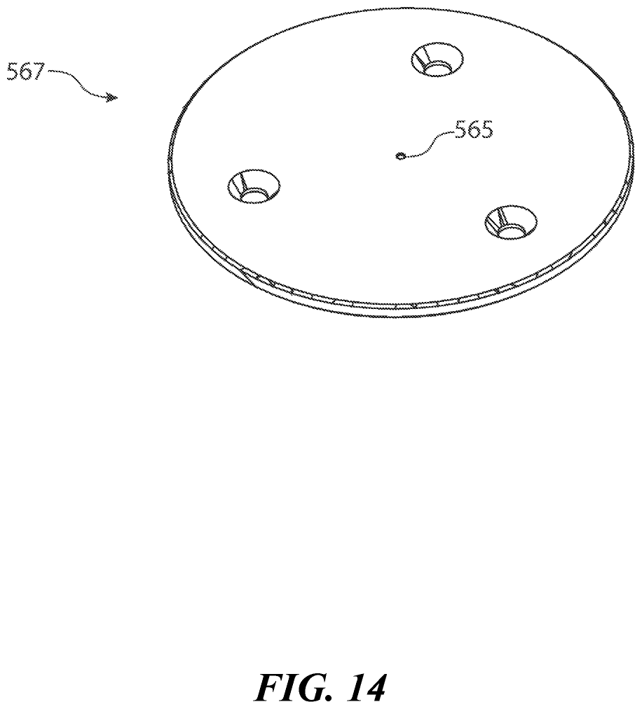

The hard stop 551 is further equipped with an ID clamp 561 that is secured to the elbow joint 509 with a suitable fastener 563 (such as, for example, a ¼-20 flat head screw). The hard stop 551 is also equipped with a plurality of fasteners 565 (such as, for example, #4-40 button head screws) which secure the body 555 of the hard stop 551 to the elbow joint 509 (using threaded holes 556 already present in the elbow joint—see FIG. 7), and a cover 567 which is secured to the hard stop 551 with a plurality of fasteners 569 (such as, for example, a plurality of #4-40 UNC flat head screws). The cover 567 is provided with a vent hole 571 (see FIG. 8) for outgassing purposes. FIGS. 11-12 show the complete assembly (hard stop 551 and elbow joint 509), and FIG. 13 shows the assembled hard stop 551.

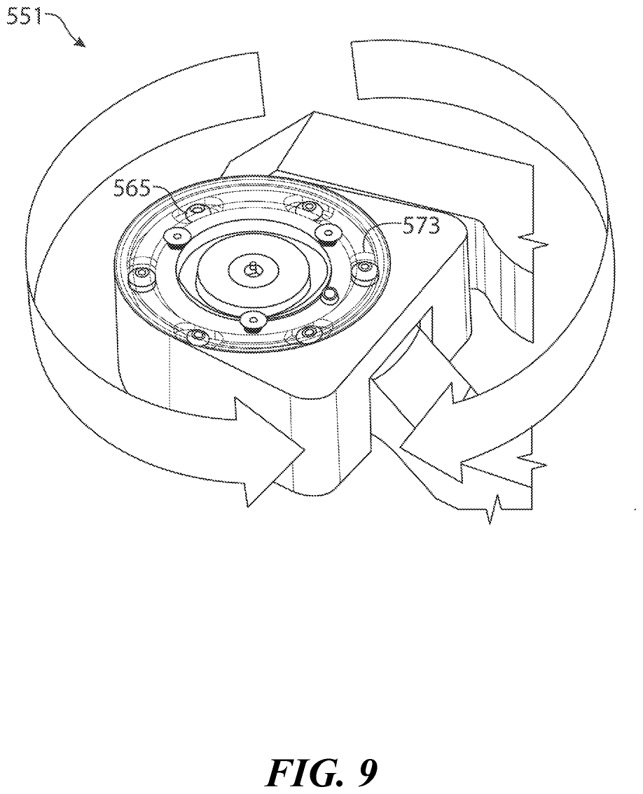

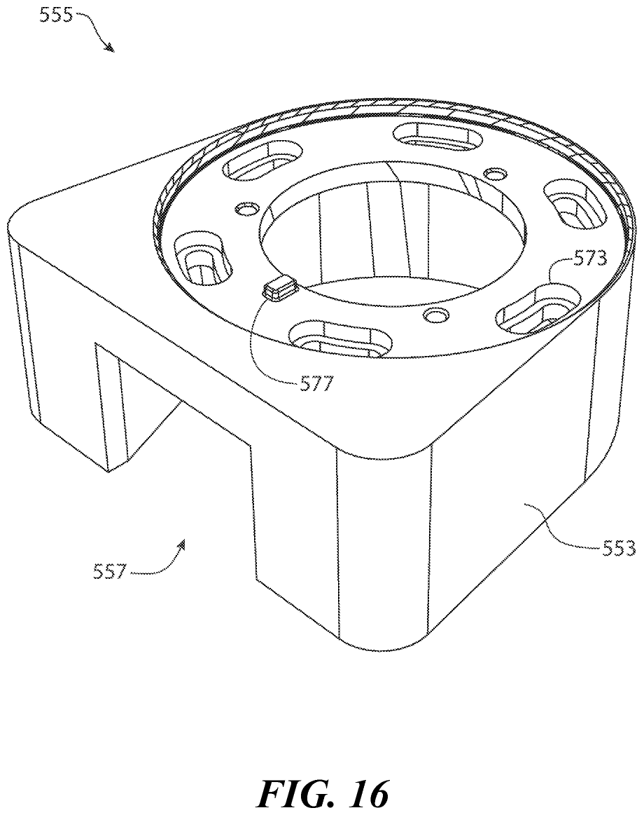

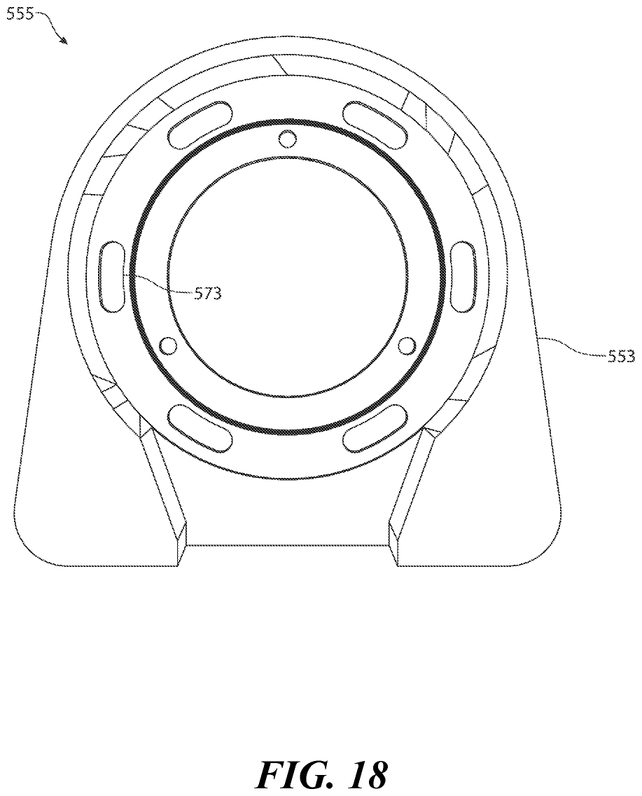

As seen in FIG. 9, the button head screws 565 protrude through slotted apertures 573 in the hard stop 551 (these apertures 573 may be seen in greater detail in FIGS. 16-18). As seen in FIG. 9, this arrangement permits a slight amount of rotational (±7.5° in the particular embodiment depicted) and linear (about ±0.29 inches in the particular embodiment depicted) adjustment in the orientation of the hard stop 551 along the radial axis of the longitudinal slots 573. This allows the orientation of the hard stop 551 to be adjusted as necessary so that the flat surface 553 of the hard stop 551 abuts, and is parallel to, the opposing surface of the upper arm 507 when the robot is in a retracted configuration.

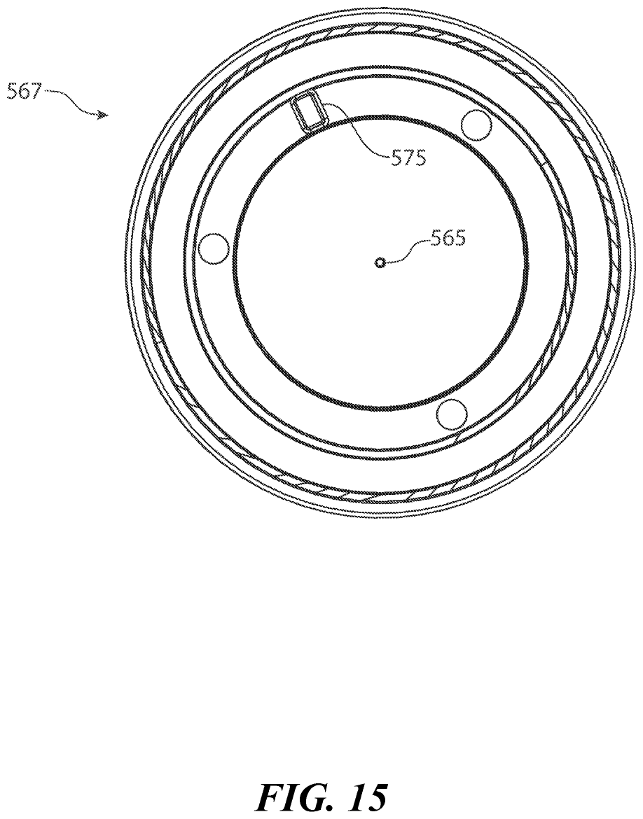

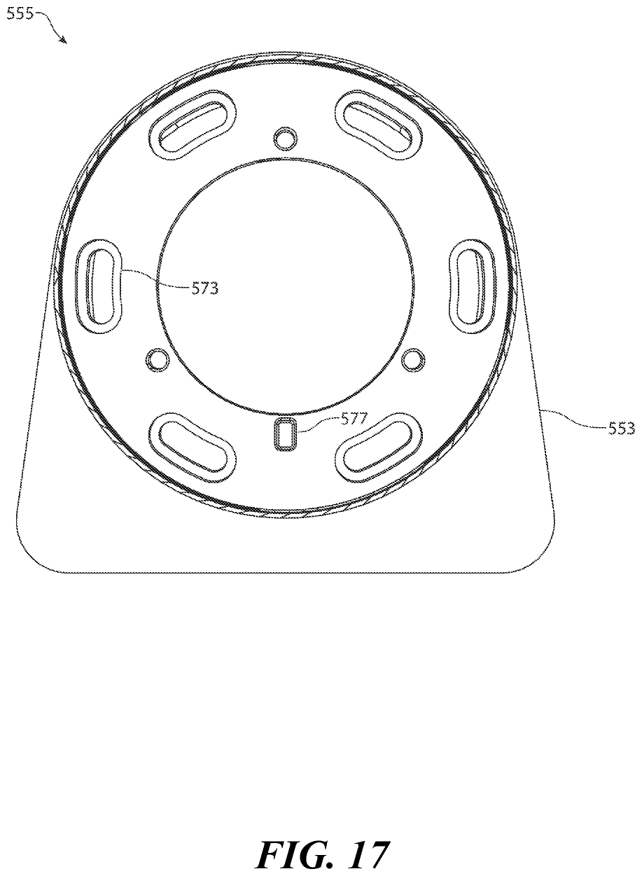

As seen in FIG. 15, the cover 567 is equipped with a first keying feature 575 that releasably couples with a second keying feature 577 in the body 555 (see FIGS. 16-17) to ensure proper orientation of the cover 567. In the particular embodiment depicted, the first keying feature 575 is an aperture and the second keying feature 577 is a protrusion which is complimentary in shape to the aperture. Of course, it will be appreciated that various numbers of keying features of various geometries may be utilized on the cover 567 or the body 555 to ensure the proper orientation of one with respect to the other.

In use, a hard stop of the type disclosed herein may be attached to one or both elbow joints of a robot (preferably a robot having a frog-leg configuration, and more preferably a robot of the general type depicted in FIG. 6). The hard stop is preferably loosely attached to the elbow joint or lower arm of the robot with a plurality of (preferably threaded) fasteners, which extend through slotted apertures provided in the hard stop (see, e.g., FIG. 16). The orientation of the hard stop on the elbow joint is then adjusted by rotating the hard stop within the range of motion permitted by the slotted apertures (see FIG. 9). Preferably, the orientation of the hard stop is adjusted until the desired spacing between the wrist assembly and the hub or hub spool is achieved, and the exterior surface of the hard stop is pressing firmly against the adjacent portion of the upper arm (and is parallel thereto). The plurality of fasteners are then tightened to lock the hard stop into this orientation.

Although the devices and methodologies disclosed herein have been specifically illustrated and explained with reference to their use in the XP Endura robot, one skilled in the art will appreciate that these devices and methodologies may be utilized, with suitable modifications as necessary, in various other robotic systems equipped with an end effector, a hub or hub spool, and a wrist assembly, and in which the normal motion of the robot brings the end effector in close proximity with the hub, the hub spool, or other parts of the robot.

The above description of the present invention is illustrative, and is not intended to be limiting. It will thus be appreciated that various additions, substitutions and modifications may be made to the above described embodiments without departing from the scope of the present invention. Accordingly, the scope of the present invention should be construed in reference to the appended claims. It will also be appreciated that the various features set forth in the claims may be presented in various combinations and sub-combinations in future claims without departing from the scope of the invention. In particular, the present disclosure expressly contemplates any such combination or sub-combination that is not known to the prior art, as if such combinations or sub-combinations were expressly written out.

What is claimed is:

1. A robot, comprising:
a hub;
a first elbow joint;
a wrist assembly;
a first upper arm rotatably attached on a first end thereof to said hub, and attached on a second end thereof to said first elbow joint;
a first lower arm attached on a first end thereof to said first elbow joint, and attached on a second end thereof to said wrist assembly; and
a first hard stop which extends over said first elbow joint and a portion of said lower arm, wherein said first hard stop has an aperture therein through which said lower arm extends;
wherein said robot is movable between a first configuration in which said wrist assembly is at a minimum distance from said hub, and a second configuration in which said wrist assembly is at a maximum distance from said hub;
wherein said lower arm rotates towards said upper arm as said robot moves from said second configuration into said first configuration; and
wherein said first hard stop has an exterior surface region which abuts said upper arm when said robot is in said first configuration.

2. The robot of claim 1, wherein said upper arm has a flattened region thereon, wherein said exterior surface region of said first hard stop is complimentary in shape to said flattened region, and wherein said exterior surface region of said first hard stop abuts said flattened region when said robot is in said first configuration.

3. The robot of claim 2, wherein said first hard stop is rotatably adjustable within a plane that is perpendicular to said flattened region on said upper arm.

4. The robot of claim 1, wherein the orientation of said first hard stop with respect to said first elbow joint is adjustable.

5. The robot of claim 4, wherein said first hard stop is affixed to said first elbow joint with a plurality of fasteners, and wherein each of said plurality of fasteners extends through a radial slot in said hard stop.

6. The robot of claim 5, wherein said plurality of fasteners are threaded fasteners which releasably engage a plurality of threaded apertures defined in said first end of said first lower arm.

7. The robot of claim 1, further comprising:
a second elbow joint;
a second upper arm rotatably attached on a first end thereof to said hub, and attached on a second end thereof to said second elbow joint; and
a second lower arm attached on a first end thereof to said second elbow joint, and attached on a second end thereof to said wrist assembly.

8. The robot of claim 7, further comprising a second hard stop which extends over said second elbow joint and a portion of said lower arm, wherein said second hard stop has an aperture therein through which said lower arm extends;

9. The robot of claim 1, wherein said first hard stop includes a portion which extends between the upper and lower arms and adjacent to the first elbow joint.

10. The robot of claim 9, wherein said portion is in contact with said upper and lower arms when the robot is in the first configuration.

11. The robot of claim 1, wherein the aperture through which said lower arm extends lies in a plane, and wherein the width of said aperture in said plane is greater than the width of said lower arm in said plane.

12. A method for restricting the motion of an elbow joint in a robot, comprising:
providing a robot equipped with
(a) a hub,
(b) a first elbow joint,
(c) a wrist assembly,
(d) a first upper arm rotatably attached on a first end thereof to said hub, and attached on a second end thereof to said first elbow joint, and
(e) a first lower arm attached on a first end thereof to said first elbow joint, and attached on a second end thereof to said wrist assembly,
wherein said robot is movable between a first configuration in which said wrist assembly is at a minimum distance from said hub, and a second configuration in which said wrist assembly is at a maximum distance from said hub, and wherein said lower arm rotates towards said upper arm as said robot moves from said second configuration into said first configuration; and
applying a first hard stop which extends over said first elbow joint and a portion of said lower arm, wherein said first hard stop has an aperture therein through which said lower arm extends, and wherein said hard stop maintains the upper and lower arms in a spaced apart configuration when the robot is in the first configuration.

13. The method of claim 12, wherein the first hard stop includes a portion which extends between the upper and lower arms adjacent to the first elbow joint.

14. The method of claim12, wherein said hard stop is equipped with a plurality of radial apertures, and wherein said hard stop is releasably attached to said elbow joint with a plurality of fasteners which extend through said radial apertures.

15. The method of claim 14, wherein the orientation of said hard stop with respect to said elbow joint is rotatably adjustable while said plurality of fasteners is in a loosened state, and is fixed when said plurality of fasteners are in a tightened state.

16. The method of claim 15, further comprising:
placing said plurality of fasteners into a loosened state;
placing the robot into the first configuration such that said wrist assembly is spaced apart from said hub and said hard stop abuts said first upper arms; and
transforming said plurality of fasteners into a tightened state.
